(19) United States
(12) Patent Application Publication
(10) Pub. No.: US 2004/0083631 A1
(43) Pub. Date: May 6, 2004

(54) Three dimensional promotional item for erecting from a single sheet of material and being collapsible back thereto

(76) Inventors: Eva Zakova, Komercni zona Pruhonice (CZ); Josef Matula, Komercni zona Pruhonice (CZ)

Correspondence Address: Charles E. Baxley, Hart, Baxley, Daniels & Holton, Fifth Floor, 59 John Street, New York, NY, 10038, US

(21) Appl. No.: 10/286,311

(22) Filed: Nov. 4, 2002

(51) Int. Cl. G09F 1/00

(52) U.S. Cl. 40/124.16; 40/124.09

(57) ABSTRACT

A three dimensional promotional item erected from a single sheet of material and collapsible back thereto. A single sheet of material includes a bottom panel foldably attached to a front panel which is foldably attached to an intermediate panel which is foldably attached to a back panel. The intermediate panel is releasibly engagable with the bottom panel and the back panel is releasibly engagable with the intermediate panel. The intermediate panel is spaced behind the front panel when the bottom panel is folded back from the front panel and the intermediate panel is folded behind the front panel and releasibly engaged with the bottom panel, and the intermediate panel is spaced in front of the back panel when the intermediate panel is folded in front of the back panel and the bottom panel is releasibly engaged with the back panel and the back panel is releasibly engaged with the intermediate panel, and in doing so, the three dimensional promotional item is erected, and is collapsed back to the single sheet of material when the erection steps are reversed.

BACKGROUND OF THE INVENTION

1. Field of the Invention

The present invention relates to a three dimensional promotional item. More particularly, the present invention relates to a three dimensional promotional item for erecting from a single sheet of material and being collapsible back thereto.

2. Description of the Prior Art

The consuming public is inundated with print advertisement, such as mail, newspaper ads, and magazine ads. This places advertisers in competition with each other to gain the attention of consumers. Prior attempts to gain the attention of consumers have included catchy slogans, startling artwork, novelty items, contests, prizes, redeemable coupons, and in some cases, even the inclusion of token sums of money. Though these traditional attempts at gaining the attention of consumers have been somewhat successful, a continuous need exists for a structure that gains the attention of consumers so as to gain more sales per advertising dollar.

Attempts to gain the attention of consumers must be capable of reaching numerous consumers in an efficient manner. Thus, the most efficient attention grabbing advertisement should be easily mass manufactured and otherwise cost effective.

A well-known method for advertising items for sale or displaying information to passers-by is to place a paper or document having information printed thereon, referred to as a “bill”, onto the surface of a wall, bulletin board, or message board. Furthermore, it is common practice to provide tearable strips along the bottom or an edge of the “bill” in order to allow an interested person to retrieve further information such as a telephone number, address, meeting time, etc. Alternatively, people may include cards or small slips of paper in an envelope stapled or glued to the “bill.”

It is common knowledge that advertisements are not entirely exclusive to the “coupon” type. Typically, cooperative advertising vehicles promoting coupons via standard ad copy, pop-up ads, or scratch off game promotions to any significance are deployed through means of magazine supplements, free standing inserts, roll off the press news prints, or direct mail applications.

These modes, while effectively proliferating mind boggling numbers of coupons, offer dismal redemption results in relation to their given proliferated numbers thereby limiting their cost effectiveness and likewise attractiveness. The more conventional format of using extremely high volume Sunday F.S.I.'s adds one of the most singly significant sources of coupon promotions into the marketplace.

Manual, e.g., trial and error, paper folding techniques have been studied for hundreds of years. Such techniques have been applied to the creation of greeting cards that unfold into complex shapes as the card is opened. Such pop-up cards have an underlying base card to which is attached several pieces that move as the card halves are actuated, e.g., opened and closed, along a fold line. Although card pieces generally operate by being placed in combination with the fold line, remote from the fold line card pieces can be actuated through use of a tab that can be affixed across the fold line to transfer the effect of actuating the card halves.

A problem with creating such designs, however, is that determining proper placement of the card pieces is largely a trial and error procedure. That is, a designer generally conceives of a design, cuts out pieces, folds and glues them, waits, and then tests the resulting construction. If it doesn't look quite right, or operate correctly, the designer's only recourse is to re-cut the pieces with slightly different shapes, fold, glue, wait, and try out this second construction. Once again, if the pieces are not formed or placed correctly, the cutting and placement steps must be repeated until the design is eventually achieved, or the designer gives up.

Folded greeting cards, advertising novelties, and pop-up books for many years have incorporated collapsible structures of paper and pasteboard which are drawn from a flat folded configuration to an upstanding, erect configuration, by the unfolding of the booklike folder. Complex composite constructions representing trees, foliage, landscapes, buildings, vehicles, animals, and people have been fabricated and sold in such collapsible pop-up form for many years. Arrayed sequences of alphabetical letters spelling a message have occasionally been displayed on sign boards forming a portion of such pop-up constructions, and individual free-standing letters or numbers have been used in many kinds of “three-dimensional” counter displays and advertising signs.

Pop-ups are used in advertising and in other promotional endeavors, whereas they had been used in the greeting card field and in children's books for a number of years. Such pop-up pieces have become generally available to the advertising field as a result of developments, for example, methods for making pop-up paper products having significant advantages over hand-assembly methods that had been generally theretofore employed, methods for making novel promotional items, particularly those which are designed to present a plurality of coupons or the like to a recipient upon the opening of a folder, and manufacturing techniques, specifically suited for mass production on a web-press or the like for making pop-up advertising pieces and the like.

The foregoing different manufacturing techniques are useful for making advertising and promotional pop-ups as a part of a continuous web arrangement, and pop-ups, such as these, have been frequently used to create impact and enjoyment in books, in greeting cards, and in advertising inserts. The foregoing advances in designs and in manufacturing methods have enabled volume production of such products at significant cost savings and thus have increased their use.

A general characteristic of such pop-ups is the movement of the pop-up element from a flat, substantially single plane into a three-dimensional orientation upon the opening of a pair of cover pieces or base pieces, generally in the form of a folder inside which the pop-up is located. By attaching the pop-up elements to opposite panels of the base pieces, for example, along angles created by lines of weakness, such as score lines and/or perforations, in combination with adhesive bonds, pressure or stress points are created which, upon opening of one cover, cause the pop-up to be erected. The pressure or stress which is created upon opening, however, is sufficient so that when the cover is manually released, it will draw the cover either partially or entirely closed.

Although a pair of base pieces have heretofore been utilized in such pop-up units, it has now been found that improved pop-up designs are feasible that eliminate one or more of the base pieces, as are methods for mass production of such improved designs.

Generally, the manufacture of pop-up structures requires a number of steps, such as printing, perforating, cutting, gluing, and folding. In order for a structure to be manufactured economically, it must be designed so that it can be produced by mass-production, or at least by machine-production, without substantial amounts of manual labor. This requirement of economic mass-production has limited the types of structures that may be formed. While more elaborate structures are desirable, the need to cut multiple panels, assemble, and glue them together renders them impractical for mass mailings.

For instance, some pop-up structures provide two interconnected hinged panels and a main display pop-up element having supporting structures or “legs” extending from the main display area. Each supporting structure or “leg” is secured to one of the two hinged panels so that when the hinged panels are unfolded, the main display area pops up from the panels. Producing such a pop-up structure requires multiple separate manufacturing steps. The two hinged panels are produced separately from the main display pop-up element, the materials are cut and printed, and then they are attached.

Additionally, pop-up structures have been manufactured to provide a resulting pop-up structure that is box-like. Such structures are formed by folding a first sheet and attaching a second sheet. The resulting structure is box-like and can draw the viewer's attention to promotional material printed on the structure. This structure requires attaching multiple sheets to each other, is relatively expensive to manufacture, and does not provide a shadowbox or an elaborate three-dimensional pop-up effect.

Advertising handouts, direct-mail pieces, and the like are being used with greater frequency to promote products and/or services. Their value often lies in the ability to command attention. Structures having pop-up elements are more likely to attract the attention of the viewer and enhance the chances that the promotional material will be read.

Advertising leaflets, inserts, mailers, novelty items, and the like have for many years utilized pop-up devices. Articles of this nature have been used to promote a particular product or service and are often used together with accompanying text in order to illustrate a particular theme or incident in a story. Although the value of such an item as an illustration is obvious, in an advertising or a promotional item, the value lies in its ability to attract attention and influence remembrance of the recipient whose business the pop-up is designed to attract. Accordingly, commercially practical items of this general type which incorporate attention-getting features remain in demand, along with ways for mass producing such items so as to make distribution economically feasible.

Because of their attention-getting raising action, pop-ups are being used with greater frequency in magazines and the like. The pop-up inserts, when used in a magazine, are bound along the magazine's binding edge with the pop-up pages opening in the same direction as the magazine pages. Due to the bulk of the magazine pages, the left hand pages of the magazine develop a curvature as it is opened. This is a normal curvature and is not objectionable if one is merely reading the page, but this curving is detrimental to those pop-ups which erect across this center fold, or “gutter”. As the left hand page, or front cover, of the pop-up curls, the pop-up refuses to erect because the fold along the base of the pop-up is not straight.

To overcome the left-hand page curling, a binding strip is often incorporated into pop-up pages. First, it moves the “gutter” away from the magazine binding edge which eases the problem somewhat. Second, it allows the inserts to be bound into books which are “perfection” bound, which is a method whereby all the pages are simply jogged or bunched into an even stack, the binding edge is then sanded under pressure, glue is applied and the entire magazine is glued together page by page at this binding edge. A cover is then “wrapped around” these pages and the entire magazine is trimmed along the top, bottom, and outer edges.

Across-the-gutter type pop-ups have an additional disadvantage. The display of the across-the-gutter type pop-ups is shown against or on top of the two facing pages. This can be somewhat awkward to a reader normally accustomed to looking at either the left or the right page when reading a magazine or similar item. A pop-up displayed against the left or the right hand page will appear to be more natural to the reader and, accordingly, will be given greater consideration than those appearing across the centerfold of the magazine.

Pop-ups have also become used in advertising and in other promotional endeavors and as novelty items to either attract attention or simply for purposes of decoration. Whereas many of these pop-up items were developed for use in mass direct-mail solicitations and the like, they have commercial interest in a form where strategically located areas of pressure-sensitive adhesive permit the simple placement of the pop-up by the recipient in an attention-attracting location.

These pop-up items are fabricated by the application of adhesive, both pressure-sensitive adhesive and bonding or permanent adhesive, to selective locations on a web in order to facilitate the mass production of such pop-up items. Generally, the fabricating methods utilize the application of release coatings or release liner materials to selectively interface with and/or protect the pressure-sensitive adhesive regions in the fabricated product. Accordingly, many of these require relatively sophisticated fabrication equipment to permit their efficient manufacture. Accordingly, improved pop-up designs have continued to be sought to simplify such manufacture.

Pop-ups in the prior art which utilize two display elements use, as an erection means, the turning of the left hand page, or front cover, to lift the top, or foreground, pop-up display element away from the bottom, or background, pop-up display element and the right hand page, or back cover. This is accomplished because the foreground display element is attached to the front cover. The foreground display element then, in turn, lifts the background display element away from the back cover via an attachment means, i.e., glue, tape, staples, etc. The most popular attachment means for the paper pop-up devices is the use of glue or cement because of their ease of application, low cost, and adhesive properties. The two pop-up elements are restrained from rotating a full one-hundred eighty degrees with the front cover and allowed to remain parallel to the back cover plane in its intended position, by another attachment, connected between the back cover and the background display element.

The attachment between the foreground and background display elements has been accomplished by gluing a spacer therebetween but this presents a number of problems. It complicates the gluing process by adding an additional surface upon which the glue must be applied, if glue is used, as is most likely. This slows the gluing and thus the manufacturing process. It also possibly reduces the gluing process to a manual application instead of an automatic application. This would naturally increase the cost of such devices.

Because pop-up structures are often transported through the mail, it is desirable that they remain substantially fiat when in the closed position. This flatness makes transport more economical and also highlights the effect of the pop-up element once the structure is placed in its open position.

As opposed to a single-display pop-up, some pop-ups utilize two pop-up display elements, that is, one pop-up display element placed on top of the other pop-up display element thus producing an effect of a foreground and a background to the display. The added weight of the additional display element further aggravates the curling effect of the opening of the left hand page and additionally hampers the across-the-gutter type pop-up's raising action.

Three-dimensional structural arrangements have long been used in greeting cards and the like and have become frequently used in advertising and in other promotional endeavors. Techniques sometimes referred to as “box-folds” have been used in greeting cards and the like, in making advertising leaflets, and the use of strips from one panel to open a flap in an opposite panel, such as in stationery items.

Numerous innovations for three dimensional promotional items have been provided in the prior art that will be described infra. Even though these innovations may be suitable for the specific individual purposes to which they address, they each differ in structure and/or operation and/or purpose from the present invention.

FOR EXAMPLE, U.S. Pat. No. 1,841,041 to Lowenstein teaches an article comprising a backing member, an inner member hingedly connected to the backing member by a fold, and a plurality of vertical folds or creases in the members to effect distention of a portion of the inner member from the backing member. The inner and outer members are separated along a part of the fold by a slit.

ANOTHER EXAMPLE, U.S. Pat. No. 1,901,661 to MacCourt et al. teaches a flat display member having illustrative material on the forward and rear faces thereof, and a reflective member positioned to the rear of the display member and adapted to reflect, to the eye of an observer, the rear face of the display member, both the direct and the reflective images being simultaneously observable by the observer, and combined spacing and supporting means adapted to maintain the display member and the reflective member in spaced relationship, and additional means for maintaining the reflective member in upright position.

STILL ANOTHER EXAMPLE, U.S. Pat. No. 2,132,649 to Sacksteder teaches a display device of sheet material comprising a back plate and a display character supported at a distance in front thereof, and a reflector extending from the back plate downwardly at a distance behind the character and turned forwardly at the bottom to the rear lower exposed end of the character.

YET ANOTHER EXAMPLE, U.S. Pat. No. 2,152,299 to Arndt teaches a device comprising an outer layer of flexible material divided into a base section and a cover section along a hinge line, an inner layer similarly divided and super-superposed upon the outer layer, a figure cut, scored, and bent from the inner layer. The figure comprises a section bendable from the base section along a lowermost score line parallel to and spaced from and below the hinge line of the inner layer, a shelf bendable from the figure section above and parallel to the lowermost score line, and a tab bendable from the shelf. The inner layer is pasted to the outer layer throughout its entire area with the exception of the figure and shelf portions to make the figure self-erecting when the cover is turned up on the hinge line.

STILL YET ANOTHER EXAMPLE, U.S. Pat. No. 2,205,262 to Hayes teaches a greeting replica comprising a sheet of postcard material having a cutout background panel extending substantially vertically and at its bottom connecting with a base panel extending to the front, a top panel continuing from the front edge of said base panel and extending rear wards on said base panel for a short distance, a vertical edge panel on the rear edge of said top panel, a. mezzanine panel continuing rearwards from the top edge of said edge panel for a short distance, a foreground panel extending vertically from the rear of said mezzanine panel, an angle tab stamped from the background panel and the base panel and having a top wall extending between said foreground panel and said background panel and also having a vertical wail secured at an upper portion to said foreground panel, and a lock lug stamped from said base panel for being bent up against said mezzanine panel and between said foreground and background panels.

YET STILL ANOTHER EXAMPLE, U.S. Pat. No. 2,609,639 to Barker teaches a greeting card comprising two sections having their adjacent edges secured together by a hinge portion and foldable thereon into overlapping relation, a movable element pivotally mounted on one section for rotation on an axis normal to the plane of said section, a contractile means secured to the outer portion of said section, an actuating cord having an intermediate portion secured to a part of the element beyond the pivot and one end fixed to the contractile means, and means for anchoring the free end of the cord to a part of the remaining section at a point removed from the hinge.

STILL YET ANOTHER EXAMPLE, U.S. Pat. No. 2,692,530 to Gowland teaches a picture viewing device comprising a cover sheet constituting a bottom member, a rear wall plate for supporting a picture, a top wall plate, and a front wall plate having at least one viewing aperture. The cover sheet and said plates are all made of stiff sheet material and all hingedly joined together along parallel lines. The front wall plate has a bottom edge parallel to said lines of junction. The bottom member has a front edge parallel to said lines of junction so that said cover sheet and all said plates jointly form a continuous strip capable of being hingedly moved into substantially parallelogram shape with such viewing aperture facing the rear wall plate and with the front wall plate projecting beyond the bottom member at said front edge of the latter. A back strip is hingedly connected to said front edge of the bottom member so as to be adapted to project downwardly thereof in surface contact with said projecting part of the front wall plate and coextensive therewith, another cover sheet hingedly connected to the free edge of the back strip, and an attachment strip is hingedly connected with said bottom edge of the front wall plate and secured to said other cover sheet, with said hinge connection between the attachment strip and front wall plate proximately coincident with that between said other cover sheet and said back strip.

YET STILL ANOTHER EXAMPLE, U.S. Pat. No. 2,742,723 to Klein et al, teaches a card having, when erected a plurality of elements disposed in various vertical and horizontal planes, all said elements being integral parts of the card blank, and said elements including a primary vertical element and a base joined thereto at a transverse fold line, a secondary vertical element, and wings on said primary vertical element, each of said wings comprising a tab portion, an intermediate portion, and a design carrying portion, all of which, are integral with said primary vertical element, with said tab and design carrying portions being separated from said intermediate portion by scores, and said intermediate portion being folded under said tab portion along one of said scores, and said design carrying portion being folded over said tab portion along the other of said scores.

STILL YET ANOTHER EXAMPLE, U.S. Pat. No. 2,102,075 to Jackson teaches an advertising sign comprising a front panel and a rear panel, said front panel having advertising letters stamped out thereon in an area defined by scored lines, said rear panel being secured to said front panel and being visible through said lettered area when the sign is in use and a support to retain the sign in the operative position.

YET STILL ANOTHER EXAMPLE, U.S. Pat. No. 3,090,144 to Malamude teaches a display device comprising a base panel and a cover panel hingedly connected together for selective movement between an open and closed position, a display panel, and an operating mechanism carried upon said base panel supporting said display panel for movement between a folded position between said base and cover panels and an erect position upstanding from said base panel in response to movement of said cover panel to said open position, wherein said operating mechanism comprises a substantially hollow prism having two pairs of sides hingedly connected together for selected movement between a collapsed position of one pair of sides upon the other and an erect hollow parallelopipedon form, a single one of said sides being secured upon said base panel, stop means limiting movement of said sides beyond said erect position from said collapsed position, and yieldable means acting between diametrically opposite edges of said parallelopipedon form yieldably urging said prism toward said erect position, wherein said stop means comprises a pair of tabs one hingedly carried at one edge by one end of a single side of one pair of sides, and another edge of each of said pair of tabs being hingedly connected to an adjacent one of said sides, each one of said tabs having a diametrical fold line defining a pair of triangular portions movable between a collapsed position one on top of the other and an axially aligned position in response to movement of said parallelopipedon between said collapsed and erect positions, whereby said triangular portions of tabs in said aligned position prevent continued movement of said prism beyond said erect position from said collapsed position.

STILL YET ANOTHER EXAMPLE, U.S. Patent Number U.S. Pat. No. 3,995,388 to Penick et al. teaches a pop-up dimensional or specialty product which is designed for mass-production, mechanical fabrication, and assembly. A base piece is formed from sheet material including a plurality of base panels, and a separate pop-up element is attached to two different base panels. Adhesive is applied to a subelement of one pop-up element, and after bringing the base panels into superposed relationship, as by folding, the subelement becomes adhesively attached to a subelement of the other pop-up element. Upon unfolding of the base piece, the pop-up elements stand up out of the plane thereof.

YET STILL ANOTHER EXAMPLE, U.S. Pat. No. 4,103,444 to Jones et al. teaches an advertising leaflet that has an attention-getting movable flap cut out from one of its sheets which is moved into raised position when the leaflet is opened by a slender activating strip which is cut out from the opposed sheet of the leaflet and has its free end glued to the flap.

STILL YET ANOTHER EXAMPLE, U.S. Pat. No. 4,146,983 to Penick et al. teaches a pop-up item for promotional purposes wherein a cover panel and a back panel, hinged to each other along a straight line, sandwich a die-cut panel in which are formed a plurality of interconnected coupons and at least two tabs. One tab is joined to the cover, and the other tab means is joined to the back. Opening of the cover causes the coupons to pop-up and attract the attention of the recipient. The items can be inexpensively mass-produced as a part of a web-press or sheet-press operation.

YET STILL ANOTHER EXAMPLE, U.S. Pat. No. 4,337,589 to Volkert et al. teaches printed paper novelty items including one or more “pop-ups” and methods for making such items designed for mass production. Promotional items of this type are formed by folding a sheet material blank so that portions constituting pop-up panels are superimposed on portions constituting base pieces. Subsequent folding operation is carried out to sandwich the pop-up panels between the base pieces and to effect adhesive attachment by earlier applied adhesive patterns, and thereafter at least one of the base pieces may be cut to eliminate an original connection between it and a pop-up panel. In the final construction, the base pieces are hinged to each other along a straight line, and each of the pop-up panels is pivotally attached to one of the base pieces along a line at an angle between about 15 degrees and about 70 degrees to the hinge line. The method may be carried out as a part of an overall web press operation or may be carried out through the use of folding machines or through a combination of both.

STILL YET ANOTHER EXAMPLE, U.S. Pat. No. 4,349,973 to Penick et al. teaches an improved promotional pop-up designs capable of fabrication by mechanical mass production, particularly as a part of a web-press operation. A pair of pop-up elements in the form of two panels which are attached to one another, preferably by adhesive, are interconnected by hinges to base pieces that constitute the halves of a folder. Automatic web-press operation can die-cut hinge elements, either within the base pieces or within the pop-up elements in the moving web. Both pop-up elements may be formed from the sheet material located adjacent one edge of a base piece, or the pop-up elements may be formed in flanking relation to the base pieces with one pop-up element along each lateral edge of the moving web, or they may alternate across the web.

YET STILL ANOTHER EXAMPLE, U.S. Pat. No. 4,520,958 to Jones et al. teaches a multi-compartment envelope for coupon nesting that includes a rectangular blank having first, second and third spaced parallel score lines defining first, second, third and fourth rectangular interconnected panels. A fold in the fourth panel provides a first panel portion and a second panel portion with the second panel portion being secured to the first panel portion and thereby providing a compartment. A slit is disposed in the compartment and divides the compartment into a first and a second compartment. A first and a second contoured slit are disposed, at least in part, in the first panel and provide a pair of wafer tabs. The first panel is in overlying relation with the second panel whereby the wafer tabs extend a substantial distance in a first direction away from the first panel. The fourth panel is folded along the third score line and overlies same while the third panel is then folded along the second score line whereby the fourth panel overlies the first panel and the third score line is proximate the first score line. The wafer tabs are folded so that a surface thereof engages the third panel and glue secures the first surface of the wafer tabs to the third panel.

STILL YET ANOTHER EXAMPLE, U.S. Pat. No. 4,592,573 to Crowell teaches a folded stationery piece that has a three-dimensional pop-up message displayed along an internal fold line, formed by an arrayed sequence of letters with the spaces between them removed. The letters and bridge webs joined to their upper edges are both hinged to the stationery panels, forming a collapsible parallelogram structure. The message display can be formed as a separate insert, to be adhesively mounted along a fold line of any piece of stationery by the user.

YET STILL ANOTHER EXAMPLE, U.S. Pat. No. 4,614,364 to Bortner teaches an advertising insert cover having a rectangular sheet folded in two to form rectangular front and back portions, attached to which are inwardly folded flap portions extending partway over the inner side of its associated cover portion for retaining loose, free standing inserts within the cover. The flap portions contain slit tear lines extending perpendicularly to the outer edge of the front and back portions and forming segments of detachable coupons. In another embodiment, the flaps are omitted and the coupon segments are formed along the outer edges of the front and/or back portions.

STILL YET ANOTHER EXAMPLE, U.S. Pat. No. 4,833,802 to Volkert teaches methods for making promotional or advertising pieces containing pop-ups on a web-press by initially printing and die-cutting a continuous web of sheet material to produce an endless series of blanks, each extending transversely across the web and being arranged to create an identical piece or folder containing one or more pop-ups. A suitable adhesive pattern is applied to the web, usually closely following the die-cutting operation which cuts at least one tab and, if desired, contours one or more of the pop-up panels. Each blank contains a pair of front and rear base pieces, a pop-up panel and a tab-containing panel, either one or both of which panels includes an actuator section. Either the tab-containing panel or the tab is adhesively affixed to the undersurface of the pop-up panel, and the other is adhesively attached to the interior surface of the rear base piece. The front base piece swings open and carries with it the adhesively attached actuator section, pulling the pop-up panel away from the plane of the rear base piece with its path of movement guided by the tab. Variations on the foregoing theme include the inclusion of two or more superimposed, staggered, or side-by-side pop-ups within a single promotional piece and/or the employment of a false backbone which determines the hinge line about which the front base piece swings. A variety of particularly efficient methods of fabrication are illustrated for making such promotional pieces as a part of a web-press operation.

YET STILL ANOTHER EXAMPLE, U.S. Pat. No. 4,949,482 to Price teaches a folded, printed product of the type often used in advertising. The product lies flat when closed, but when open or unfolded, a section of the product forms a three-dimensional box. The box section has a tongue extending above it, providing a particularly prominent section for displaying important information.

STILL YET ANOTHER EXAMPLE, U.S. Pat. No. 4,963,125 to Volkert teaches promotional pieces including pop-up structures and methods for mass production on a web press or the like. After manipulating the web to create a double thickness in a region of two pop-up panels, die-cutting of the double-thickness region creates an identical pattern along edges of these panels which creates a desired artistic effect found earlier in hand-assembled items. These pieces may have a pop-up structure which includes a tunnel-like construction having apertures formed along a hinge line between two panels. Die-cutting may also be performed along both edges of a pair of folded-over pop-up panels.

YET STILL ANOTHER EXAMPLE, U.S. Pat. No. 5,078,670 to Volkert teaches pop-up items which can either be mounted in three-dimensional form on a suitable supporting surface by means of pressure-sensitive adhesive carried by the item or can be affixed to facing panels of a letter or pages of a book. The item may include one or more base pieces plus a pop-up element or a pop-up element alone in the form of one or two panels. When one base piece is attached, or when mounted between facing panels, upon opening, the pop-up element assumes a three-dimensional configuration as a result of pressure-sensitive adhesive bonding to the surface of a facing panel or page. A variety of methods for the mass production of such pop-up items from a continuous web, e.g., the printed and die-cut web from a web press, facilitate their inexpensive fabrication. These items are preferably marketed or distributed in groups, e.g., attached to a continuous strip of sheet material that might be rolled or fan-folded, or in the form of stacks or pads from which a single item can be peeled off and affixed.

STILL YET ANOTHER EXAMPLE, U.S. Pat. No. 5,181,901 to Volkert teaches pop-up items which can either be mounted in three-dimensional form on a suitable supporting surface by means of pressure-sensitive adhesive carried by the item or can be affixed to facing panels of a letter or pages of a book. The item may include one or more base pieces plus a pop-up element or a pop-up element alone in the form of one or two panels. When one base piece is attached, or when mounted between facing panels, upon opening, the pop-up element assumes a three-dimensional configuration as a result of pressure-sensitive adhesive bonding to the surface of a facing panel or page. A variety of methods for the mass production of such pop-up items from a continuous web, e.g., the printed and die-cut web from a web press, facilitate their inexpensive fabrication. These items are preferably marketed or distributed in groups, e.g., attached to a continuous strip of sheet material that might be rolled or fan-folded, or in the form of stacks or pads from which a single item can be peeled off and affixed.

YET STILL ANOTHER EXAMPLE, U.S. Pat. No. 5,346,455 to Volkert teaches pop-up items which can either be mounted in three-dimensional form on a suitable supporting surface by means of pressure-sensitive adhesive carried by the item or can be affixed to facing panels of a letter or pages of a book. The preferred items include a pop-up element in the form of one or two panels carrying strategically located pressure-sensitive adhesive which permits instant mounting, e.g., between facing panels so that, upon opening, the pop-up element assumes a three-dimensional configuration as a result of the pressure-sensitive adhesive bonding to the surfaces of facing panels or pages. The 3-dimensional pop-up can also be mounted to any suitable supporting surface. A variety of methods for the mass production of such pop-up elements from a continuous web, e.g., a printed and die-cut web from a web press, facilitate their inexpensive fabrication. These pop-up elements are preferably marketed or distributed in groups, e.g., defined by perforations within a surrounding matrix, or attached to a continuous strip of carrier sheet material that might be rolled or fan-folded, or in the form of stacks or pads from which a single item can be peeled off and affixed.

STILL YET ANOTHER EXAMPLE, U.S. Pat. No. 5,943,800 to Rose teaches a pop-up structure or sticker for use with two hinged panels that includes a display area, and is provided with transparent supporting legs or other structure, secured to both of the two hinged panels so that the pop-up structure or sticker folds flat when the panels are closed and pops up and appears to “float” over the hinged panels when they are opened.

It is apparent that numerous innovations for three dimensional promotional items have been provided in the prior art that are adapted to be used. Furthermore, even though these innovations may be suitable for the specific individual purposes to which they address, they would not be suitable for the purposes of the present invention as heretofore described.

### SUMMARY OF THE INVENTION

ACCORDINGLY, AN OBJECT of the present invention is to provide a three dimensional promotional item for erecting from a single sheet of material and being collapsible back thereto that avoids the disadvantages of the prior art.

ANOTHER OBJECT of the present invention is to provide a three dimensional promotional item for erecting from a single sheet of material and being collapsible back thereto that is simple to use.

BRIEFLY STATED, STILL ANOTHER OBJECT of the present invention is to provide a three dimensional promotional item erected from a single sheet of material and collapsible back thereto. A single sheet of material includes a bottom panel foldably attached to a front panel which is foldably attached to an intermediate panel which is foldably attached to a back panel. The intermediate panel is releasibly engagable with the bottom panel and the back panel is releasibly engagable with the intermediate panel. The intermediate panel is spaced behind the front panel when the bottom panel is folded back from the front panel and the intermediate panel is folded behind the front panel and releasibly engaged with the bottom panel, and the intermediate panel is spaced in front of the back panel when the intermediate panel is folded in front of the back panel and the bottom panel is releasibly engaged with the back panel and the back panel is releasibly engaged with the intermediate panel, and in doing so, the three dimensional promotional item is erected. The three dimensional promotional item is collapsed back to the single sheet of material when the back panel is released from the intermediate panel, the bottom panel is released from the back panel, the back panel is folded coplanarly with the intermediate panel, the intermediate panel is released from the bottom panel, the bottom panel is folded coplanarly with the front panel, and the front panel is folded coplanarly with the intermediate panel.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective view of the three dimensional promotional item for erecting from a single sheet of material and being collapsible back thereto of the present invention erected;

FIG. 2 is a diagrammatic top plan view of the single sheet of material utilized for erecting the three dimensional promotional item for erecting from a single sheet of material and being collapsible back thereto of the present invention shown in FIG. 1;

FIG. 3 is a diagrammatic bottom plan view of the single sheet of material shown in FIG. 2 and utilized for erecting the three dimensional promotional item for erecting from a single sheet of material and being collapsible back thereto of the present invention shown in FIG. 1; and

FIG. 4 is a diagrammatic perspective view of the three dimensional promotional item for erecting from a single sheet of material and being collapsible back thereto of the present invention being erected or collapsed from the single sheet of material shown in FIGS. 2 and 3.

### LIST OF REFERENCE NUMERALS UTILIZED IN THE DRAWING

10 three dimensional promotional item of present invention for erecting from single sheet of material and being collapsible back thereto

12 single sheet of material

14 back panel of single sheet of material 12

16 intermediate panel of single sheet of material 12

18 front panel of single sheet of material 12

20 bottom panel of single sheet of material 12

22 inner edge of back panel 14 of single sheet of material 12

24 lower edge of back panel 14 of single sheet of material 12

26 outer edge of back panel 14 of single sheet of material 12

28 front surface of back panel 14 of single sheet of material 12

30 inner edge of intermediate panel 16 of single sheet of material 12

32 upper edge of intermediate panel 16 of single sheet of material 12

34 lower edge of intermediate panel 16 of single sheet of material 12

36 outer edge of intermediate panel 16 of single sheet of material 12

38 front surface of intermediate panel 16 of single sheet of material 12

40 upper edge of front panel 18 of single sheet of material 12

42 lower edge of front panel 18 of single sheet of material 12

44 front surface of front panel 18 of single sheet of material 12

46 front edge of bottom panel 20 of single sheet of material 12

48 back edge of bottom panel 20 of single sheet of material 12

50 intermediate line of bottom panel 20 of single sheet of material 12

52 first fold line of single sheet of material 12

54 second fold line of single sheet of material 12

56 third fold line of single sheet of material 12

58 pair of tabs on lower edge 34 of intermediate panel 16 of single sheet of material 12

60 pair of through slots in intermediate line 50 of bottom panel 20 of single sheet of material 12

62 through slot in lower edge 24 of back panel 14 of single sheet of material 12

64 tab of back edge 48 of bottom panel 20 of single sheet of material 12

66 through slot in outer edge 36 of intermediate panel 16 of single sheet of material 12

68 tab on outer edge 26 of back panel 14 of single sheet of material 12

70 indicia on front surface 28 of back panel 14 of single sheet of material 12

72 void in intermediate panel 16 of single sheet of material 12

74 indicia on front surface 38 of intermediate panel 16 of single sheet of material 12

76 void in front panel 18 of single sheet of material 12

78 indicia on front surface 44 of front panel 18 of single sheet of material 12

### DETAILED DESCRIPTION OF THE PREFERRED EMBODIMENT

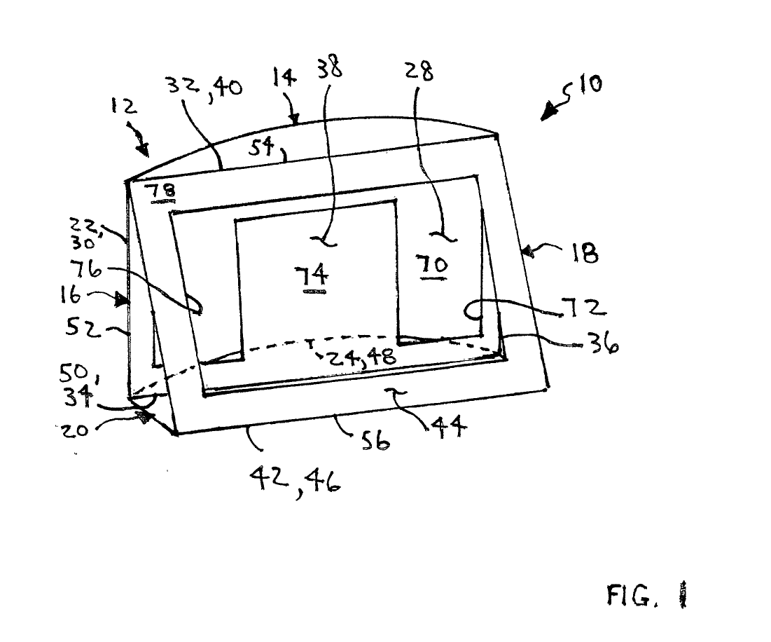

Referring now to the figures, in which like numerals indicate like parts, and particularly to FIG. 1, which is a diagrammatic perspective view of the three dimensional promotional item for erecting from a single sheet of material and being collapsible back thereto of the present invention erected, the three dimensional promotional item of the present invention is shown generally at 10 for erecting from a single sheet of material and being collapsible back thereto.

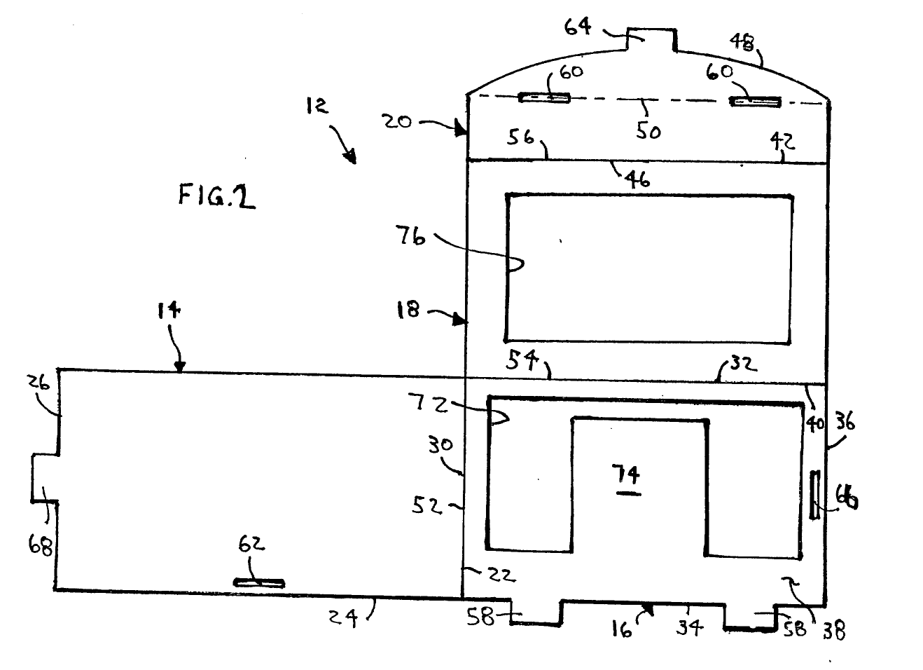

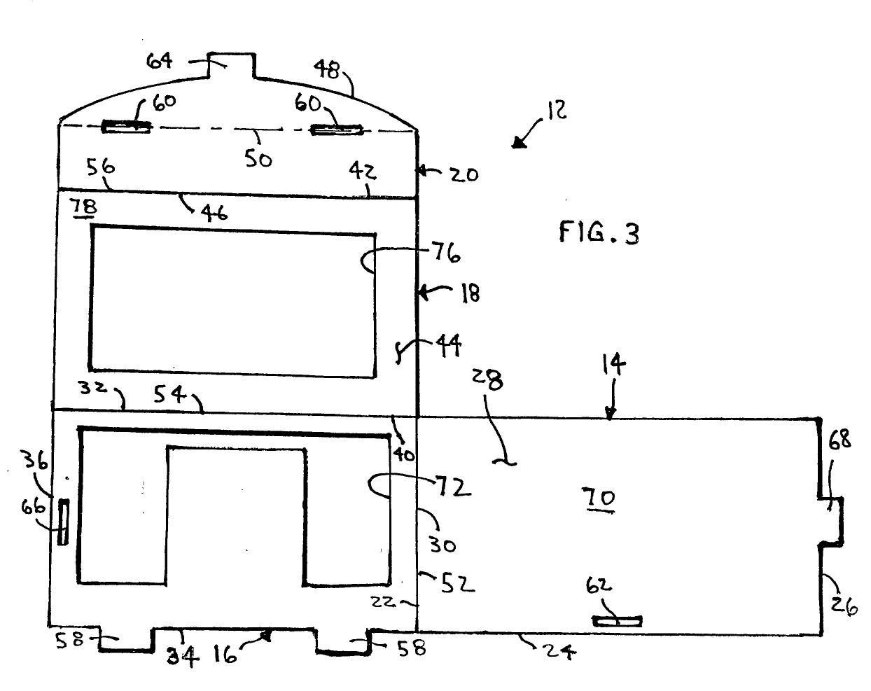

As shown in FIGS. 2 and 3, which are, respectively, a diagrammatic top plan view of the single sheet of material utilized for erecting the three dimensional promotional item for erecting from a single sheet of material and being collapsible back thereto of the present invention shown in FIG. 1, and a diagrammatic bottom plan view of the single sheet of material shown in FIG. 2 and utilized for erecting the three dimensional promotional item for erecting from a single sheet of material and being collapsible back thereto of the present invention shown in FIG. 1, the three dimensional promotional item 10 comprises a single sheet of material 12. The single sheet of material 12 comprises a back panel 14, an intermediate panel 16, a front panel 18, and a bottom panel 20.

The intermediate panel 16 is foldably attached to the back panel 14, the front panel 18 is foldably attached to the intermediate panel 16, and the bottom panel 20 is foldably attached to the front panel 18.

The intermediate panel 16 is releasibly engagable with the bottom panel 20, the bottom panel 20 is releasibly engagable with the back panel 14, and the back panel 14 is releasibly engagable with the intermediate panel 16.

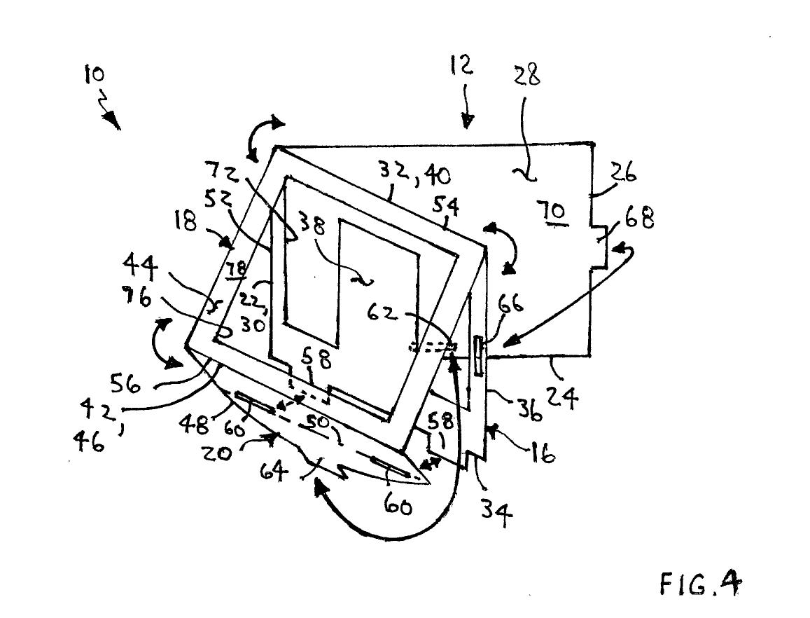

As shown in FIGS. 1 and 4 which is a diagrammatic perspective view of the three dimensional promotional item for erecting from a single sheet of material and being collapsible back thereto of the present invention being erected or collapsed from the single sheet of material shown in FIGS. 2 and 3, the intermediate panel 16 is spaced behind the front panel 18 when the bottom panel 20 is folded back from the front panel 18 and the intermediate panel 16 is folded behind the front panel 18 and releasibly engaged with the bottom panel 20, and the intermediate panel 16 is spaced in front of the back panel 14 when the intermediate panel 16 is folded in front of the back panel 14 and the bottom panel 20 is releasibly engaged with the back panel 14 and the back panel 14 is releasibly engaged with the intermediate panel 16, and in doing so, the three dimensional promotional item 10 is erected.

The three dimensional promotional item 10 is collapsed back to the single sheet of material 12 when the back panel 14 is released from the intermediate panel 16, the bottom panel 20 is released from the back panel 14, the back panel 14 is folded coplanarly with the intermediate panel 16, the intermediate panel 16 is released from the bottom panel 20, the bottom panel 20 is folded coplanarly with the front panel 18, and the front panel 18 is folded coplanarly with the intermediate panel 16.

Returning now to FIGS. 1-4, the back panel 14 has an inner edge 22, a lower edge 24, an outer edge 26, and a front surface 28. The intermediate panel 16 has an inner edge 30, an upper edge 32, a lower edge 34, an outer edge 36, and a front surface 38. The front panel 18 has an upper edge 40, a lower edge 42, and a front surface 44. The bottom panel 20 has an front edge 46, a back edge 48, and an intermediate line 50 that is intermediate the front edge 46 thereof and the back edge 48 thereof.

The inner edge 22 of the back panel 14 is coincident with the inner edge 30 of the intermediate panel 16 and form a first fold line 52 on which the intermediate panel 16 is foldably attached to the back panel 14. The upper edge 32 of the intermediate panel 16 is coincident with the upper edge 40 of the front panel 18 and form a second fold line 54 on which the front panel 18 is foldably attached to the intermediate panel 16. The lower edge 42 of the front panel 18 is coincident with the front edge 46 of the bottom panel 20 and form a third fold line 56 on which the bottom panel 20 is foldably attached to the front panel 18.

The lower edge 34 of the intermediate panel 16 is releasibly engaged with the intermediate line 50 of the bottom panel 20 so as to space the intermediate panel 16 behind the front panel 18. The back edge 48 of the bottom panel 20 is releasibly engaged with the lower edge 24 of the back panel 14 and the outer edge 26 of the back panel 14 is releasibly engaged with the outer edge 36 of the intermediate panel 16 so as to space the intermediate panel 16 in front of the back panel 14.

The back edge 48 of the bottom panel 20 is convex so as to cause the back panel 14 to arch there against so as to be spaced therebehind even though the inner edge 30 of the intermediate panel 16 is foldably attached to the inner edge 22 of the back panel 14 and the outer edge 26 of the back panel 14 is releasibly engaged with the outer edge 36 of the intermediate panel 16.

As shown in FIGS. 2-4, the lower edge 34 of the intermediate panel 16 has a pair of tabs 58 that are spaced apart therealong. The intermediate line 50 of the bottom panel 20 has a pair of through slots 60 that are spaced apart therealong. The pair of tabs 58 on the lower edge 34 of the intermediate panel 16 releasibly engage in the pair of through slots 60 in the intermediate line 50 of the bottom panel 20, respectively, so as to releasibly engage the intermediate panel 16 with the bottom panel 20.

The lower edge 24 of the back panel 14 has a through slot 62 that extends centrally therealong. The back edge 48 of the bottom panel 20 has a tab 64 that extends centrally thereon. The tab 64 on the back edge 48 of the bottom panel 14 releasibly engages in the through slot 62 in the lower edge 24 of the back panel 14 so as to releasibly engage the bottom panel 20 with the back panel 14.

The outer edge 36 of the intermediate panel 16 has a through slot 66 that extends centrally therealong. The outer edge 26 of the back panel 14 has a tab 68 that extends centrally therefrom. The tab 68 of the outer edge 26 of the back panel 14 releasibly engages in the through slot 66 in the outer edge 36 of the intermediate panel 16 so as to releasibly engage the back panel 14 with the intermediate panel 16.

As shown in FIGS. 1-4, the front surface 28 of the back panel 14 faces the intermediate panel 16 and has indica 70 thereon that is,for example, a background scene, but is not limited to that. The intermediate panel 16 has a void 72 therein that allows the indicia 70 on the front surface 28 of the back panel 14 to be visible therethrough even though it is spaced therebehind.

The front surface 38 of the intermediate panel 16 faces the front panel 18 and has indicia 74 thereon that is,for example, a figure, but is not limited to that. The indicia 74 on the front surface 38 of the intermediate panel 16 visually cooperates with the indicia 70 on the front surface 28 of the back panel 14 which is visible through the void 72 in the intermediate panel 16 even though it is spaced therebehind.

The front panel 18 has a void 76 therein. The void 76 in the front panel 18 allows the indicia 70 on the front surface 28 of the back panel 14 and the indicia 74 on the front surface 38 of the intermediate panel 16 to be visible therethrough even though they are spaced therebehind.

The front surface 44 of the front panel 18 has indica 78 thereon that is,for example, a border, but is not limited to that. The indicia 78 on the front surface 44 of the front panel 18 visually cooperates with the indicia 70 on the front surface 28 of the back panel 14 and the indicia 74 on the front surface 38 of the intermediate panel 16 which are visible through the void 76 in the front panel 18 even though they are spaced therebehind.

It will be understood that each of the elements described above, or two or more together, may also find a useful application in other types of constructions differing from the types described above.

While the invention has been illustrated and described as embodied in a three dimensional promotional item for erecting from a single sheet of material and being collapsible back thereto, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A three dimensional promotional item for erecting from a single sheet of material and being collapsible back thereto, said promotional item comprising a single sheet of material;
wherein said single sheet of material comprises:
a) a back panel;
b) an intermediate panel;
c) a front panel; and
d) a bottom panel;
wherein said intermediate panel is foldably attached to said back panel;
wherein said front panel is foldably attached to said intermediate panel;
wherein said bottom panel is foldably attached to said front panel;
wherein said intermediate panel is releasibly engagable with said bottom panel;
wherein said bottom panel is releasibly engagable with said back panel;
wherein said back panel is releasibly engagable with said intermediate panel; and
wherein said intermediate panel is spaced behind said front panel when said bottom panel is folded back from said front panel and said intermediate panel is folded behind said front panel and releasibly engaged with said bottom panel, and said intermediate panel is spaced in front of said back panel when said intermediate panel is folded in front of said back panel and said bottom panel is releasibly engaged with said back panel and said back panel is releasibly engaged with said intermediate panel, and in doing so, said three dimensional promotional item is erected, and said three dimensional promotional item is collapsed back to said single sheet of material when said back panel is released from said intermediate panel, said bottom panel is released from said back panel, said back panel is folded coplanarly with said intermediate panel, said intermediate panel is released from said bottom panel, said bottom panel is folded coplanarly with said front panel, and said front panel is folded coplanarly with said intermediate panel.

2. The promotional item as defined in claim 1, wherein said back panel has an inner edge;
wherein said intermediate panel has an inner edge; and
wherein said inner edge of said back panel is coincident with said inner edge of said intermediate panel and form a first fold line on which said intermediate panel is foldably attached to said back panel.

3. The promotional item as defined in claim 1, wherein said intermediate panel has an upper edge;
wherein said front panel has an upper edge; and
wherein said upper edge of said intermediate panel is coincident with said upper edge of said front panel and form a second fold line on which said front panel is foldably attached to said intermediate panel.

4. The promotional item as defined in claim 2, wherein said front panel has a lower edge;
wherein said bottom panel has an front edge; and
wherein said lower edge of said front panel is coincident with said front edge of said bottom panel and form a third fold line on which said bottom panel is foldably attached to said front panel.

5. The promotional item as defined in claim 4, wherein said intermediate panel has a lower edge;
wherein said bottom panel has a back edge;
wherein said bottom panel has an intermediate line;
wherein said intermediate line of said bottom panel is intermediate said front edge thereof and said back edge thereof; and
wherein said lower edge of said intermediate panel is releasibly engagable with said intermediate line of said bottom panel so as to space said intermediate panel behind said front panel.

6. The promotional item as defined in claim 5, wherein said back panel has a lower edge;
wherein said back panel has an outer edge;
wherein said intermediate panel has an outer edge; and
wherein said back edge of said bottom panel is releasibly engaged with said lower edge of said back panel and said outer edge of said back panel is releasibly engaged with said outer edge of said intermediate panel so as to space said intermediate panel in front of said back panel.

7. The promotional item as defined in claim 5, wherein said lower edge of said intermediate panel has a pair of tabs;
wherein said pair of tabs on said lower edge of said intermediate panel are spaced apart therealong;
wherein said intermediate line of said bottom panel has a pair of through slots;
wherein said pair of through slots in said intermediate line of said bottom panel are spaced apart therealong; and
wherein said pair of tabs on said lower edge of said intermediate panel releasibly engage in said pair of through slots in said intermediate line of said bottom panel so as to releasibly engage said intermediate panel with said bottom panel.

8. The promotional item as defined in claim 6, wherein said lower edge of said back panel has a through slot;
wherein said through slot in said lower edge of said back panel extends centrally therealong;
wherein said back edge of said bottom panel has a tab;
wherein said tab on said back edge of said bottom panel extends centrally therefrom; and
wherein said tab on said back edge of said bottom panel releasibly engages in said through slot in said lower edge of said back panel so as to releasibly engage said bottom panel with said back panel.

9. The promotional item as defined in claim 6, wherein said outer edge of said intermediate panel has a through slot;
wherein said through slot in said outer edge of said intermediate panel extends centrally therealong;
wherein said outer edge of said back panel has a tab;
wherein said tab on said outer edge of said back panel extends centrally therefrom; and
wherein said tab on said outer edge of said back panel releasibly engages in said through slot in said outer edge of said intermediate panel so as to releasibly engage said back panel with said intermediate panel.

10. The promotional item as defined in claim 1, wherein said back panel has a front surface;
wherein said front surface of said back panel faces said intermediate panel; and
wherein said front surface of said back panel has indica thereon.

11. The promotional item as defined in claim 10, wherein said intermediate panel has a void therein; and
wherein said void in said intermediate panel allows said indicia on said front surface of said back panel to be visible therethrough even though it is spaced therebehind.

12. The promotional item as defined in claim 11, wherein said intermediate panel has a front surface;
wherein said front surface of said intermediate panel faces said front panel;
wherein said front surface of said intermediate panel has indicia thereon; and
wherein said indicia on said front surface of said intermediate panel visually cooperates with said indicia on said front surface of said back panel which is visible through said void in said intermediate panel therethrough even though it is spaced therebehind.

13. The promotional item as defined in claim 12, wherein said front panel has a void; and
wherein said void in said front panel allows said indicia on said front surface of said back panel and said indicia on said front surface of said intermediate panel to be visible therethrough even though they are spaced therebehind.

14. The promotional item as defined in claim 13, wherein said front panel has a front surface;
wherein said front surface has indica thereon; and
wherein said indicia on said front surface of said front panel visually cooperates with said indicia on said front surface of said back panel and said indicia on said intermediate panel which are visible through said void in said front panel therethrough even though they are spaced therebehind.

15. The promotional item as defined in claim 6, wherein said back edge of said bottom panel is convex so as to cause said back panel to arch there against so as to be spaced therebehind even though said inner edge of said intermediate panel is foldably attached to said inner edge of said back panel and said outer edge of said back panel is releasibly engaged with said outer edge of said intermediate panel.

16. The promotional item as defined in claim 12, wherein said indicia on said front surface of said back panel is a background scene.

17. The promotional item as defined in claim 16, wherein said indicia on said front surface of said intermediate panel is a figure; and
wherein said figure on said front surface of said intermediate panel visually cooperates with said background scene on said front surface of said back panel.

18. The promotional item as defined in claim 14, wherein said indicia on said front surface of said front panel is a border.
